(19) United States
(12) Patent Application Publication
(10) Pub. No.: US 2019/0102750 A1
(43) Pub. Date: Apr. 4, 2019

(54) APPARATUS AND METHOD FOR DETERMINING A MAINTENANCE SCHEDULE

(71) Applicant: General Electric Company, Schenectady, NY (US)

(72) Inventors: Janet Convery, Salem, VA (US); Eran Rae Diokno Del Castillo, Atlanta, GA (US); Maria Maenza, Greenville, SC (US); Ezgi Caliskan, Atlanta, GA (US); Alen Korjenic, Atlanta, GA (US); Thomas Billheimer, Atlanta, GA (US); Carlos Hein, Greenville, SC (US); Bradford Foulkes, Greenville, SC (US); Benjamin Lagrange, Greenville, SC (US)

(21) Appl. No.: 15/722,400

(22) Filed: Oct. 2, 2017

(51) Int. Cl. G06Q 10/00; G06Q 10/06; G06Q 30/02; G06F 3/0484

(52) U.S. Cl. CPC G06Q 10/20; G06Q 10/06312; G06F 3/04847; G06Q 10/0639; G06Q 30/0206; G06Q 10/06375

(57) ABSTRACT

Upon application of first inputs and for a first proposed maintenance event, a lifing model responsively produces a cost of an unplanned failure for an asset. Upon application of second inputs, a performance analysis model responsively produces a cost of degradation of performance of the asset over time. A projected revenue for the asset is based upon third inputs. A profitability of the asset is determined for the first proposed maintenance event. Subsequently, one or more of the first inputs, the second inputs, or the third inputs are adjusted based upon a second proposed maintenance event, and an adjusted profitability determined for the proposed second maintenance event. The adjusted profitability is displayed at the display. One of the proposed maintenance events is selected.

### BACKGROUND OF THE INVENTION

### Field of the Invention

The subject matter disclosed herein generally relates to industrial machines, and, more specifically, to the maintenance schedules associated with these industrial machines.

### Brief Description of the Related Art

Industrial equipment, machines, or assets, generally, are engineered to perform particular tasks as part of a business process. For example, industrial assets can include, among other things and without limitation, manufacturing equipment on a production line, wind turbines that generate electricity on a wind farm, healthcare or imaging devices (e.g., X-ray or MRI systems) for use in patient care facilities, or drilling equipment for use in mining operations. Other types of industrial assets may include vehicles such as fleets of trucks. The design and implementation of these assets often takes into account both the physics of the task at hand, as well as the environment in which such assets are configured to operate.

Industrial equipment, machines, or assets need to undergo maintenance in order to continue to operate properly. In some examples, the maintenance is periodically scheduled. In other instances, the maintenance is unscheduled, such as when the machine breaks down.

Maintenance activities can be conducted according to schedules. To take one example in the power generation industry, while planning maintenance over the lifetime of combined cycle power plants, the customer selects the schedule that best optimizes cost, performance, and reliability (e.g., the $/MwH).

No scheduling tool currently exists that merges analysis of performance, lifing/reliability, and net imputed revenue to plan and optimize utilization of a portfolio of power plants. Because of this, in planning plant outages, customers have to separately consult multiple teams and applications to determine the best point in the unit's lifetime to undergo maintenance.

In fact, the current approaches for planning maintenance activities require the customer to make calculations guided by maintenance manuals, which does not take into account unit specific operational impact factors. Furthermore, current risk estimations do not quantify the impact of risk in terms that show the impact to the customer's financial bottom line, and ignore the question of the maximum amount of acceptable risk.

### BRIEF DESCRIPTION OF THE INVENTION

The present invention is directed to scheduling maintenance through utilization of empirical and physics-based models and the analysis of operational data to project future profitability as a function of, for example, performance, reliability, and market conditions. These approaches compare the effects of degradation and unplanned outage risk by assigning a consequence that these factors pose to profitability as a function of the operational profile of a machine (e.g., a power generating unit).

The approaches described herein can be implemented so as to be specific to an individual unit's or machine's operation through the usage of maintenance factors and fitted performance curves based on past operation. Additionally, the user may provide inputs to test multiple scenarios based on maintenance timing, scope, and spot prices. In some aspects, the system then indicates the ongoing increased profitability of the inputted values and automatically compares the trade-off of the immediate costs of planned maintenance versus the long-term profit benefit as a return on investment.

In many of these embodiments, first inputs are applied to a lifing model that describes the reliability of an asset. Upon application of the inputs, the lifing model responsively produces a cost of an unplanned failure for an asset. Second inputs are applied to a performance analysis model. Upon application of the inputs, the performance analysis model responsively produces a cost of degradation of performance of the asset over time. A projected revenue for the asset is determined based upon third inputs. A profitability of the asset is determined based upon the revenue for an asset, the cost of the unplanned failure for the asset, and the cost of degradation.

The profitability is rendered to a user on a display. Other actions are possible. This profitability may be based upon first, second, and third inputs that are associated with a maintenance event.

Subsequently, one or more of the first inputs, the second inputs, or the third inputs are adjusted according to a second proposed maintenance event, and an adjusted profitability is rendered to the user at the display. One of the first or second proposed maintenance events is selected for implementation. The selection is effective to balance the profitability of the asset with an immediate cost of the selected maintenance event.

In aspects, the first or second maintenance event includes a maintenance schedule and a maintenance scope. In examples, the first inputs relate to the cost of labor, the cost of parts to be replaced, or lost revenue due to the first or second proposed maintenance event. In other examples, the second inputs relate to past performance data of the asset. In still other examples, the third inputs relate to costs associated with utilizing the asset. In some aspects, the costs are fuel costs for an electric power plant.

The asset may be a wide variety of assets. In one example, the asset is an electrical power plant or machine. Other examples are possible.

In others of these embodiments, a system includes an interface, a database, and a control circuit. The interface is configured to receive first inputs, second inputs, and third inputs.

The database is configured to store a lifing model that describes the reliability of an asset. The database also stores a performance analysis model. The performance analysis model models a cost of degradation of performance of the asset over time.

The control circuit is coupled to the interface and the database. The control circuit is configured to, for a first proposed maintenance event, apply the first inputs to a lifing model, and the lifing model responsively produces a cost of an unplanned failure for the asset. The control circuit is further configured to apply the second inputs to a performance analysis model, and the performance analysis model responsively produces a cost of degradation of performance of the asset over time. The control circuit is also configured to determine a projected revenue for the asset based upon the third inputs. The control circuit is still further configured to obtain a profitability of the asset based upon the revenue for an asset, the cost of the unplanned failure for the asset, and the cost of degradation. The control circuit configured to render the profitability associated with the first proposed maintenance event to a user on a display via the interface.

Subsequently, one or more of the first inputs, the second inputs, or the third inputs are adjusted according to a second proposed maintenance event, and an adjusted profitability is rendered to the user at the display. One of the first or second proposed maintenance events is selected, and the selection is effective to balance the profitability of the asset with an immediate cost of the selected maintenance event.

### BRIEF DESCRIPTION OF THE DRAWINGS

For a more complete understanding of the disclosure, reference should be made to the following detailed description and accompanying drawings wherein:

FIG. 1 comprises a block diagram of a system for determining an optimum maintenance schedule according to various embodiments of the present invention;

FIG. 2 comprises a flow diagram of an approach for determining an optimum maintenance schedule according to various embodiments of the present invention;

FIGS. 3A and 3B comprise block diagrams of a user dashboard according to various embodiments of the present invention.

Skilled artisans will appreciate that elements in the figures are illustrated for simplicity and clarity. It will further be appreciated that certain actions and/or steps may be described or depicted in a particular order of occurrence while those skilled in the art will understand that such specificity with respect to sequence is not actually required. It will also be understood that the terms and expressions used herein have the ordinary meaning as is accorded to such terms and expressions with respect to their corresponding respective areas of inquiry and study except where specific meanings have otherwise been set forth herein.

### DETAILED DESCRIPTION OF THE INVENTION

In the present approaches, maintenance activities or events are scheduled through utilization of empirical and physics-based models and the analysis of operational data to project future profitability as a function of, for example, performance, reliability, and market conditions.

One example of these approaches may be implemented in the power generation industry. For a power generation unit or set of units within a power generation facility, data is gathered for the configuration, parts, operational history, and performance. Reliability models developed for the parts and configurations using fleet experience and physics analysis are applied to the unit, as well as an operational impact factor that utilizes past and projected operation variables to scale the risk of an unplanned outage or failure that is expected for the specific machine's conditions at each point in time in the future. Performance degradation models for output and efficiency are scaled using the performance data to determine how the performance of the unit is expected to change as it ages.

With these models, forecasts, operating costs, and data, the resulting electricity production and fuel consumption of the units can be combined to provide a measure of the combined cycle, power generation facility, or portfolio's overall production and consumption over time. Projections for the unit's electricity and fuel prices are combined with these outputs to generate a measure of net revenue, that the plant would be gaining from the selling of electricity. The failure models and risk are then assigned a consequence to profitability by the durations of the failure being associated with a loss of generation of electricity and subsequent loss of profit.

In addition, the cost of an unplanned outage is multiplied by the risk of an outage to provide a probabilistic cost deducted from the revenue. The scheduling and scope of maintenance events, along with the operating scheme, can then be adjusted to optimize the revenue metric given, capitalizing on periods of high opportunity for revenue.

The present invention, in aspects, provides financial incentive behind timing and scope of maintenance, in addition to major decisions such as equipment upgrades, parts swapping, and operating schemes (part-load or peak-load, starts-based, etc.). Any scenario involving an impact to reliability and performance could then be compared based on their impact to profitability. Also, multiple units across a portfolio could be managed based on their individual history and profiles.

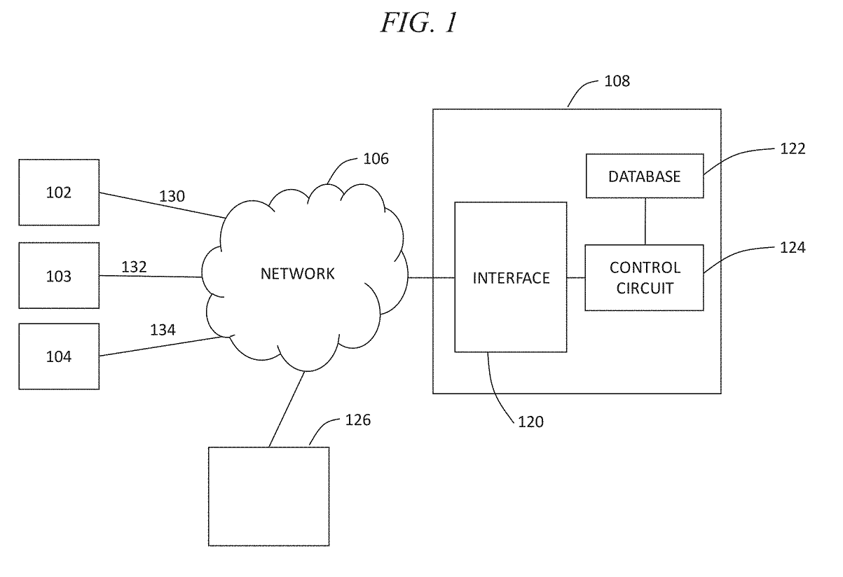

Referring now to FIG. 1, a system for scheduling maintenance activities and performing other actions is described. The system includes data sources 102, 103, and 104, a network 106, and an apparatus 108. The apparatus 108 includes an interface 120, a database 122, and a control circuit 124. A display 126 may be any type of electronic display on a device such as a personal computer, tablet, laptop, or cellular phone.

The data sources 102, 103, and 104 may be from the same or different electronic devices (e.g., computers, laptops, tablets, cellular phones, computer memories, other data storage devices, processors, communication devices, or any combination of these or other electronic devices) supplying different types of information. In examples, the data may include the first inputs 130, second inputs 132, and third 133. Although three data sources are shown it will be appreciated that any number of data sources are possible. Also, the data sources may be located at customer locations (e.g., factories, offices, buildings), at central processing centers, at home offices, at business centers, or at any other location.

The first inputs 130, second inputs 132, and third inputs 134 are electronic signals or transmissions that carry information. In examples, the first inputs 130 relate to the cost of labor, the cost of parts to be replaced, or lost revenue due to a maintenance event. In aspects, the second inputs 132 relate to past performance data of the asset. In still other examples, the third inputs 134 relate to costs associated with utilizing the asset. For instance, when the asset is an electric power plant or generator the costs may be fuel costs for an electric power plant.

The network 106 may be any type of electronic communication network or combination of networks. The network 106 may include devices such as gateways, routers, or processors. In one example, the network 106 is the cloud.

As mentioned, the apparatus 108 includes an interface 120, a database 122, and a control circuit 124. The interface 120 is coupled to the network and is configured to transmit information or receive information from the network 106.

The database 122 is any type of memory storage device. The database 122 is configured to store a lifing model that describes the reliability of an asset. The database 122 also stores a performance analysis model. The performance analysis model models a cost of degradation of performance of the asset over time. The lifing model and the performance analysis models may be implemented as equations or sets of equations in one example. These models may be implemented as any type of data structures or combination of data structures. The exact structure of the lifing model and the performance analysis model will vary based upon the physical and operational characteristics of an asset and other factors.

The control circuit 124 is coupled to the database 122 and the interface 120. It will be appreciated that as used herein the term “control circuit” refers broadly to any microcontroller, computer, or processor-based device with processor, memory, and programmable input/output peripherals, which is generally designed to govern the operation of other components and devices. It is further understood to include common accompanying accessory devices, including memory, transceivers for communication with other components and devices, etc. These architectural options are well known and understood in the art and require no further description here. The control circuit 124 may be configured (for example, by using corresponding programming stored in a memory as will be well understood by those skilled in the art) to carry out one or more of the steps, actions, and/or functions described herein.

In one example of the operation of the system of FIG. 1, the control circuit 124 is configured to, for a first proposed maintenance event, apply the first inputs 130 to a lifing model, and the lifing model responsively produces a cost of an unplanned failure for an asset. The control circuit 124 is further configured to apply the second inputs 132 to a performance analysis model, and the performance analysis model responsively produces a cost of degradation of performance of the asset over time. The control circuit 124 is also configured to determine a projected revenue for the asset based upon the third inputs 134.

The control circuit 124 is still further configured to obtain a profitability of the asset based upon the revenue for an asset, the cost of the unplanned failure for the asset, and the cost of degradation. For example, the cost of the unplanned failure for the asset and the cost of degradation may be summed as a total cost, and the total cost subtracted from the revenue to obtain profitability for the first proposed maintenance event. The control circuit 124 configured to render the profitability associated with the first proposed maintenance event to a user on the display 126 via the interface 120. As mentioned, the display 134 may be incorporated into an electronic device such as a personal computer, laptop, tablet, or cellular phone. The electronic device may also be used to enter (e.g., via a keyboard or touch screen). In other words, the electronic device may incorporate one or more of the data sources 102, 103, and 104 and be used to enter one or more of the first inputs 130, second inputs 132, or third inputs 134.

Subsequently, one or more of the first inputs 130, the second inputs 132, or the third inputs 134 are adjusted according to a proposed second maintenance event, and an adjusted profitability is rendered to the user at the display for the second proposed maintenance event. One of the first or second proposed maintenance events is selected, and the selection is effective to balance the profitability of the asset with an immediate cost of the selected maintenance event. For example, profitability curves associated with two different maintenance events (e.g., maintenance schedules) can be compared side-by-side to determine which profitability curve is preferable (and hence, which maintenance schedule to follow).

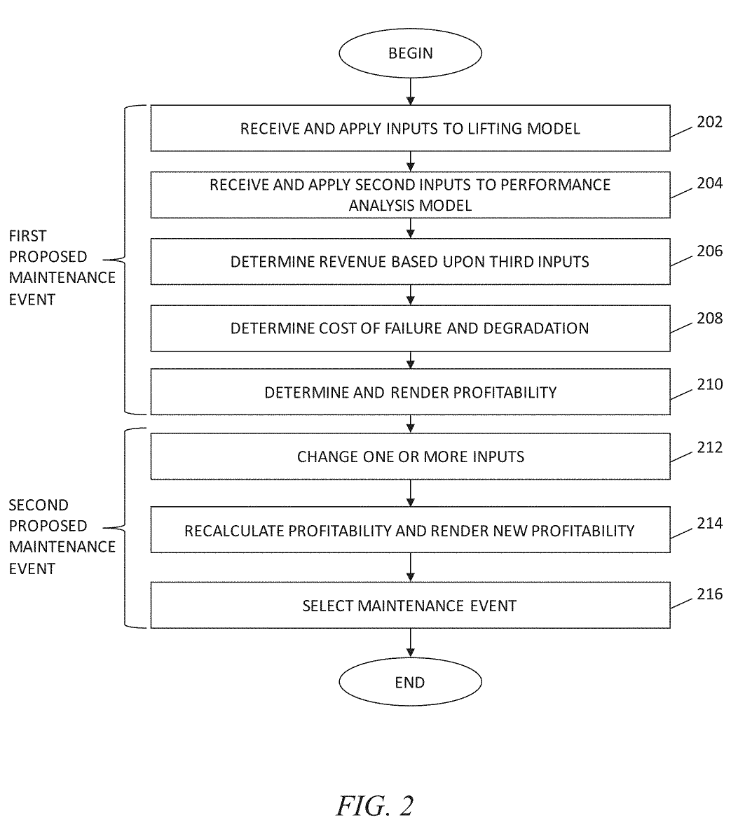

Referring now to FIG. 2, one approach for determining an optimum maintenance schedule is described. In this example, it is assumed that the asset is a power generation device or group of devices.

At step 202 and for a first proposed maintenance event, first inputs to a lifing model that describes the reliability of an asset. Upon application of the first inputs, the lifing model responsively produce a cost of an unplanned failure for an asset. The lifing model may be a mathematical equation, set of equations, or mathematical relationship that yields a cost when the first inputs are applied.

At step 204 and for the first proposed maintenance event, second inputs are applied to a performance analysis model. Upon application of the second inputs, the performance analysis model responsively produces a cost of degradation of performance of the asset over time. The performance analysis model may be a mathematical equation, set of equations, or mathematical relationship that yields a cost of degradation when the second inputs are applied. The cost may be in dollars, to take one example.

At step 206 and for the first proposed maintenance event, a projected revenue for the asset is determined based upon third inputs. For example, if the asset is a power generation device and the fuel costs are known, then the projected revenue for the asset can be obtained according to, for example, a mathematical equation or relationship.

At step 208 and for the first proposed maintenance event, a profitability of the asset is determined based upon the revenue for an asset, the cost of the unplanned failure for the asset, and the cost of degradation. For example, the cost of the unplanned failure for the asset and the cost of degradation may be summed as a total cost, and the total cost subtracted from the revenue to obtain profitability.

At step 210, the profitability for the first proposed maintenance event is rendered to a user on an electronic display. The profitability may be shown as a projected profitability of the asset over time. Other parameters (e.g., revenue) may also be shown. It will be understood that some (or all) of the first inputs, second inputs, and third inputs may be user selected, while others of these inputs may be obtained from other data sources. If the inputs are user selected, a user interface such as a touch screen or keypad may be used to enter different ones of the inputs. Others of the inputs may not vary (e.g., these inputs are fixed and come from an electronic data source).

Subsequently, at step 212, one or more of the first inputs, the second inputs, or the third inputs are adjusted according to a second proposed maintenance event, and an adjusted profitability is rendered to the user at the display for the second proposed maintenance event.

At step 214, one of the proposed first or second maintenance events is selected. The selection is effective to balance the profitability of the asset with an immediate cost of the selected maintenance event. The profitability may be shown as a projected profitability of the asset over time. Other parameters (e.g., revenue) may also be shown.

The selection may be made manually or automatically (without human supervision or interaction). When the selection is made a manually and the profitability is shown as a graph, the graphs can be lined up, for example, one on top of the other, so that a visual comparison can be made by a user.

When the selection is made automatically, predetermined parameters can be used to make the selection. For example, a computer program can be used to determine the curve have the greatest profitability and then that profitability is automatically selected.

It will be appreciated that once a profitability is selected, that profitability is associated with a particular maintenance schedule. The selected maintenance schedule can be, in one example, communicated electronically to maintenance personnel. In still other examples, electronic signals from a control circuit (e.g., the control circuit 124 of FIG. 1) can be created that implement a maintenance schedule. For instance, electronic signals may be created that take an asset off-line (temporarily deactivate or partially deactivate the asset) according to the parameters (e.g., time, date, duration) of the maintenance schedule.

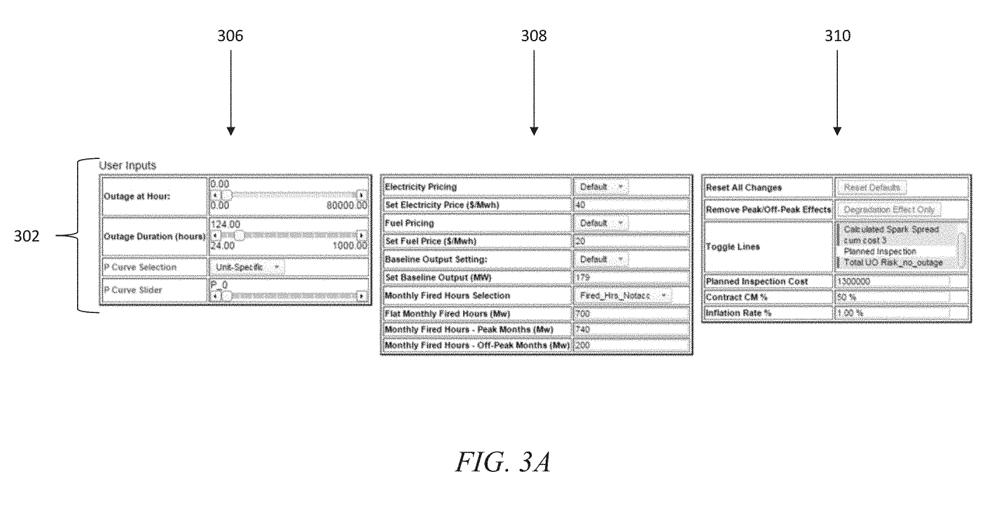

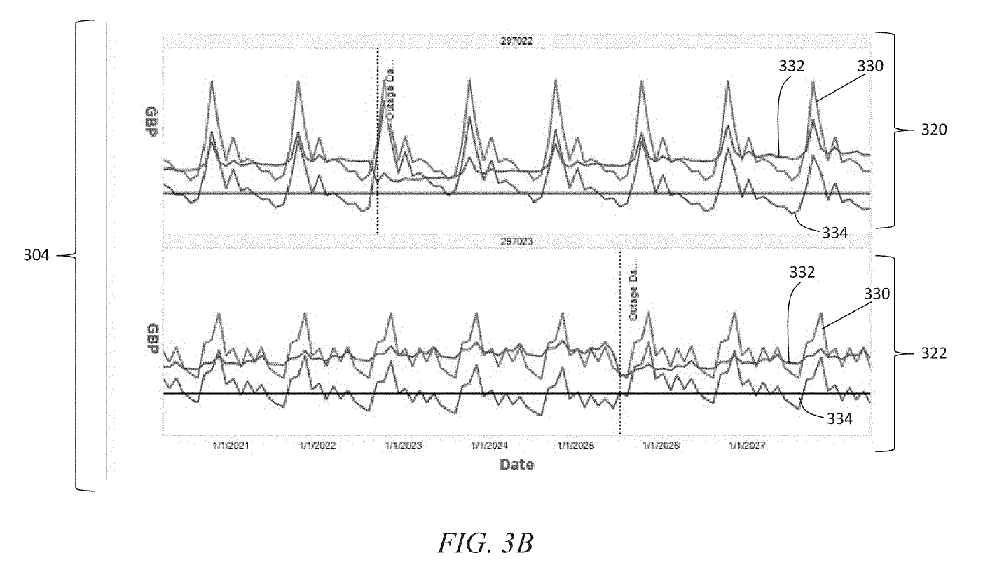

Referring now to FIG. 3A and FIG. 3B, one example of a user dashboard 300 where a user enters information and is presented with profitability curves generated at least in part from the user-entered information is described. The example of FIG. 3 shows a dashboard associated with electrical power generation (e.g., for an electrical power generator or plant). It will be appreciated that the dashboard shown in FIG. 3 is only one example and that other examples are possible.

The dashboard includes a user input section 302 and a graphical display section 304. Generally speaking, the user enters inputs into the user input section 302 and the system produces one or more outputs (e.g., graphs) based upon the inputs. Various profitability values can be visually compared and an appropriate maintenance schedule determined.

In one example, a user selects in a general area 306 of section 302 an outage time and a length to see a predicted recovery. The user may select a degradation scheme, use unit operational data, or choose a particular profitability curve to display.

In general area 308 of section 302, the user also selects the static price of electricity and the fuel of choice (to produce the electricity). The user may also use price predictions. The user may also set the operation by selecting the baseline output and monthly fired hours (when the machine is fired), or choose to use historical monthly fired hours.

In general area 310 of section 302, the user may isolate the effect of degradation or reset all the inputs. The user may adjust financial information, set inspection costs, set contracts, and set the inflation rate.

Display section shows a first group of curves 320 and a second group of curves 322. The first set of curves 320 may be produced for a first machine, while the second group of curves may be produced for a second machine.

Each of the sets has a first curve 330, a second curve 332, and a third curve 334. The first curve 330 represents the monthly net revenue. The monthly net revenue may be defined by the selling price of the electricity generated minus the buying price for the fuel and operating costs required to generate the sold electricity.

The second curve 332 represents the unplanned outage risk cost. The unplanned outage risk cost is defined as the product of the risk of an unplanned outage, and the unplanned outage risk cost (including the cost of downtime).

The third curve 334 represents net profit. Net profit is the monthly net imputed revenue minus the unplanned risk cost.

It will be appreciated that users can adjust various parameters via the inputs to see changes to the result curves (e.g., the sets 320 and 322). Each time the inputs are changed shows a different maintenance event for each machine. The user may then select one of the proposed maintenance events so as to balance the profitability of the asset with an immediate cost of the selected maintenance event. Alternatively, an automatic selection of the maintenance event may be made according to predetermined criteria (e.g., election of the event with the lowest overall costs).

It will be appreciated by those skilled in the art that modifications to the foregoing embodiments may be made in various aspects. Other variations clearly would also work, and are within the scope and spirit of the invention. It is deemed that the spirit and scope of the invention encompasses such modifications and alterations to the embodiments herein as would be apparent to one of ordinary skill in the art and familiar with the teachings of the present application.

What is claimed is:

1. A method, comprising:
applying first inputs to a lifing model that describes the reliability of an asset, the lifing model responsively producing a cost of an unplanned failure for an asset;
applying second inputs to a performance analysis model, the performance analysis model responsively producing a cost of degradation of performance of the asset over time;
determining a projected revenue for the asset based upon third inputs;
wherein the first inputs, second inputs, and third inputs are defined as for a proposed first maintenance event;
obtaining a profitability of the asset based upon the revenue for an asset, the cost of the unplanned failure for the asset, and the cost of degradation;
rendering the profitability to a user on a display for the first proposed maintenance event;
subsequently, adjusting one or more of the first inputs, the second inputs, or the third inputs according to a proposed second maintenance event of the asset, and determining and rendering an adjusted profitability to the user at the display for the second proposed maintenance event at the display;
selecting one of the first or second proposed maintenance events, the selecting being effective to balance the profitability of the asset with an immediate cost of the selected maintenance event.

2. The method of claim 1, wherein the first or second proposed maintenance event includes a maintenance schedule and a maintenance scope.

3. The method of claim 1, wherein the first inputs relate to the cost of labor, the cost of parts to be replaced, or lost revenue due to the first or second maintenance event.

4. The method of claim 1, wherein the second inputs relate to past performance data of the asset.

5. The method of claim 1, wherein the third inputs relate to costs associated with utilizing the asset.

6. The method of claim 5, wherein the costs are fuel costs and operating costs for an electric power plant.

7. The method of claim 1, wherein the asset is an electrical power plant.

8. A system, comprising:
an interface that is configured to receive first inputs, second inputs, and third inputs;
a database that is configured to store a lifing model that describes the reliability of an asset, the database also storing a performance analysis model, the performance analysis model responsively modeling a cost of degradation of performance of the asset over time;
a control circuit coupled to the interface and the database, the control circuit configured to, for a first proposed maintenance event, apply the first inputs to a lifing model, the lifing model responsively producing a cost of an unplanned failure for an asset, the control circuit further configured to apply the second inputs to a performance analysis model, the performance analysis model responsively producing a cost of degradation of performance of the asset over time, the control circuit also configured to determine a projected revenue for the asset based upon the third inputs, the control circuit further configured to obtain a profitability of the asset based upon the revenue for an asset, the cost of the unplanned failure for the asset, and the cost of degradation, the control circuit configured to rendering the profitability associated with the first proposed maintenance event to a user on a display via the interface;
wherein subsequently, one or more of the first inputs, the second inputs, or the third inputs are adjusted according to a second proposed maintenance event, and an adjusted profitability is determined and rendered to the user at the display for the second proposed maintenance event; and
wherein one of the first or second proposed maintenance events is selected, and the selection is effective to balance the profitability of the asset with an immediate cost of the selected maintenance event.

9. The system of claim 8, wherein the parameters of the first or second proposed maintenance event includes a maintenance schedule and a maintenance scope.

10. The system of claim 8, wherein the first inputs relate to the cost of labor, the cost of parts to be replaced, or lost revenue due to the first or second maintenance event.

11. The system of claim 8, wherein the second inputs relate to past performance data of the asset.

12. The system of claim 8, wherein the third inputs relate to costs associated with utilizing the asset.

13. The system of claim 12, wherein the costs are fuel costs and operating costs for an electric power plant.

14. The system of claim 8, wherein the asset is an electrical power plant.
